(19) United States
(12) Patent Application Publication
(10) Pub. No.: US 2025/0292446 A1
(43) Pub. Date: Sep. 18, 2025

(54) VIDEO GRAPHIC OVERLAY DEVICE AND METHOD

(71) Applicant: Stripe Studios Inc., Ottawa (CA)

(72) Inventors: Michael King, Ottawa (CA); Jonathan King, Ottawa (CA)

(21) Appl. No.: 19/079,111

(22) Filed: Mar. 13, 2025

Related U.S. Application Data
(60) Provisional application No. 63/565,418, filed on Mar. 14, 2024.

(51) Int. Cl. G06T 11/00; G06T 1/20; G06T 11/40; H04N 21/431; H04N 21/81; H04N 21/8547

(52) U.S. Cl. CPC G06T 11/00; G06T 1/20; G06T 11/001; G06T 11/40; H04N 21/4312; H04N 21/8146; H04N 21/8547

(57) ABSTRACT

A graphic overlay device and method for creating a graphic image of time-specific data that can be synchronized with video and audio. A video graphic overlay image can be populated with a data stream input relevant to a video stream, live or pre-recorded, and can be combined with a high resolution video stream. This provides broadcasters and video producers a way to enhance their multi-media capabilities and program quality while improving speed, robustness, reliability, efficiency and story-telling capabilities, particularly during live broadcasts.

### CROSS-REFERENCE TO RELATED APPLICATIONS

This application claims priority to U.S. provisional patent application 63/565,418 filed 14 Mar. 2024, which is hereby incorporated by reference herein in its entirety.

### FIELD OF THE INVENTION

The present invention pertains to a device and method for overlaying graphical elements on a video stream.

### BACKGROUND

Video broadcast production involves selecting the input from one or more media sources and outputting the selections to create a program. Media source contributions that are put together to create a program can come from one or more cameras, microphones, graphical overlays, stored audio and video, and stored or on-the-fly modified video and audio such as slow motion clips and special effects. In professional live video broadcasts such as a broadcast of sports games or concerts, data is captured from multiple media sources and assembled as a single program stream by a team of video production professionals. In live broadcast the allowable time for assembly of the final video broadcast production is limited, and production decisions are rapid and require rapid response times from technicians as well as the technology they employ to modify and finalize the media source contributions used in the final live broadcast.

Modern video production for live and prepared broadcast and streaming often uses graphical overlays to enhance the video. Graphic overlays come in various forms and styles depending on the video type, and are used in a wide variety of applications including in video conferencing, weather and traffic reporting, sports and e-sports broadcasting, and news broadcasting. Graphic overlays appearing over a video stream can present as, for example, images, icons, video marking or telestration, text such as player or speaker names, as well as data including statistics, score, and clock data. Increasingly, graphic overlays are being used to present augmented reality data extracted from live telemetry data sources, such as comparative or predictive ball and vehicle trajectories in sports, as well as data from statistics databases, to provide enhanced broadcasts.

In an example of broadcast control, U.S. Pat. No. 10,013,154B2 to Stoneham et al. describes a broadcast control apparatus for visual data with a touch screen display panel to receive and display visual data simultaneously in real time from a plurality of visual sources and a graphical panel. Stoneham et al. also provides a description of the role of the multiple technicians in a production crew who contribute to a live professional broadcast.

To accommodate the increased graphical data density in a live broadcast, graphic overlay templates must be designed carefully in advance of the live broadcast in order to successfully integrate with externally integrated telemetry, database data, and clock and score data, to minimize delay during a live event. Graphics templates are generally stored on laptop computers or on the internet or cloud, and technician access to these templates is done by accessing these data stores, downloading the template, and populating the template with broadcast specific data. Problems exist when access speeds are slow, such as delayed internet data transfer through cloud networks, when template access is hindered such as when templates files are moved or reconfigured, and when templates become inaccessible or corrupted such as due to reconfiguration of external devices and systems, for example as a result of software updates.

In live broadcast there is no time for delay or error. Pre-designed and tested graphic overlays capable of integrating with relevant data that are easily accessible and controllable to the technician responsible for the graphics component of the broadcast improves workflow and provides a more reliable work product in a stressful live environment. Rapid and reliable access to graphics templates is essential for smooth and timely broadcast production, in particular during live broadcast.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a device and method for creating a graphic image of time-specific data that can be synchronized with video and audio.

In an aspect there is provided a video graphic overlay device comprising: a memory comprising a graphics engine for providing a graphic element template; a video input port for receiving a video stream and a video stream timecode; a data input port for receiving a data stream pertinent to the video stream; a graphics processor for receiving the graphic element template from the graphics engine and the data stream and generating a graphic element overlay incorporating sampled data from the data stream; a display screen for displaying the video stream and the graphic element overlay; and an output port for outputting an output data stream comprising the video graphic overlay synchronized with the video stream timecode.

In an embodiment, the output data stream comprises a fill output for relaying an output fill and a key output for relaying an output key for the video graphic overlay.

In another embodiment, the graphic element template and the video graphic overlay comprise a color channel (RGB) and an alpha channel (A).

In another embodiment, the data input port, the video input port, and the output comprise a port selected from a High-Definition Multimedia Interface (HDMI) port and a serial digital interface (SDI) port.

In another embodiment, the device further comprises an interpolation engine to receive the data stream and interpolate the sampled data from the data stream.

In another embodiment, the device further comprises an integrated power supply.

In another embodiment, the data stream comprises one or more of a historical data set, a real time data set, and a generated data set.

In another embodiment, the graphics engine comprises at least one of a graphic library and a graphic generation engine.

In another embodiment, the output data stream further comprises the video stream.

In another aspect there is provided a computer-implemented method for applying a video graphic overlay to a video comprising: receiving a video data stream comprising a video stream and a video stream timecode; receiving a data stream pertinent to the video stream; generating a graphic element overlay by selecting a graphic element template from a graphics engine and incorporating sampled data from the data stream into the graphic element template; providing the graphic element overlay to a video buffer to provide a video graphic overlay; and outputting an output data stream comprising the video graphic overlay synchronized with the video stream timecode.

In an embodiment, the video graphic overlay is overlayed onto a synchronized live video stream using the video stream timecode. In another embodiment, the video graphic overlay is overlayed onto a high resolution video stream.

In another embodiment, the method further comprises interpolating the sampled data from the data stream to provide interpolated data and incorporating the interpolated data into the graphic element template to generate the graphic element overlay.

In another embodiment, interpolating the data input extrapolates a future event based on the interpolated data.

In another embodiment, the method further displaying the video graphic overlay with a high resolution video stream to provide a video product, the video graphic overlay synchronized with the high resolution video stream according to the video stream timecode.

In another embodiment, the video graphic overlay comprises an output fill and an output key.

In another embodiment, the graphic element template is provided by a graphics engine.

In another aspect, there is provided video graphic overlay device comprising: a memory comprising a graphics library with at least one graphic element template; a graphics processor connected to the memory for receiving the at least one graphic element template; a video buffer connected to the graphics processor; a video input for receiving a video stream, the video stream comprising a video timecode; a data input for receiving a data stream pertinent to the video stream, the data stream comprising a data timecode synchronized with the video timecode; a fill output for relaying an output fill; and a key output for relaying an output key.

In an embodiment, the device further comprises a display screen for displaying the video input and the graphic element overlay.

In another embodiment, the at least one graphic element template is a telestrator graphic, clock and score, chyron, ticker, static graphic, augmented static graphic, augmented video effect, or animation.

In another embodiment, the data input, the video input, the fill output, and the key output comprise a port selected from an HDMI port and an SDI port.

In another embodiment, the device is independent from an external network.

In another embodiment, the device further comprises one or more of a Wi-Fi antenna, fan, and thermostat.

In an embodiment, the device further comprises an integrated power supply.

In an embodiment, the device further comprises an interpolation engine to receive live data and interpolate a trend between two or more datapoints in the live data.

In another aspect there is provided a computer-implemented method for applying a graphical element to a video comprising: receiving a video data stream comprising a video and a video timecode identifying at timestamp each frame in the video; receiving a data input with a data timecode, the data timecode synchronized with the video timecode; selecting a graphic element for overlay onto the video, the graphic element comprising a data field which can be populated with a data input relevant to the video at or near the timestamp identified by the video timecode, the graphic element comprising an output fill and an output key; inserting the data input into the graphic element; and combining the graphic element with the video.

In an embodiment, the video stream is a live video stream.

In another embodiment, the method further comprises interpolating the data input to interpolate a trend between two or more timestamps in the video data stream. In another embodiment, interpolating the data input extrapolates a future event based on the trend.

In another embodiment, the method further comprises displaying the video stream and the graphic element synchronized according to the timecode.

In another embodiment, combining the graphic element with the video is done at a production device comprising one or more of a video keyer and a production switcher.

In another embodiment, the graphic element template is a telestrator graphic, clock and score, chyron, ticker, static graphic, augmented static graphic, augmented video effect, or animation.

In another aspect there is provided a computer-implemented method for creating a graphical element for a video comprising: receiving a video stream comprising a plurality of frames and a video timecode comprising a timestamp for each frame in the video stream; receiving a data input comprising a data timecode; selecting a graphic element template comprising a data field, the graphic element comprising an image and a transparency for the image; populating the data field in the graphic element with the data input as identified by the timecode; and displaying the video stream and the graphic element synchronized according to the timecode.

In an embodiment, the data populated is interpolated around the timestamp.

Embodiments of the present invention as recited herein may be combined in any combination or permutation.

### BRIEF DESCRIPTION OF THE FIGURES

For a better understanding of the present invention, as well as other aspects and further features thereof, reference is made to the following description which is to be used in conjunction with the accompanying figures which illustrate embodiments or aspects of the invention, where:

FIG. 1 illustrates an embodiment of a graphic overlay device for providing a video graphic overlay;

FIG. 2A illustrates an embodiment of a graphic overlay device for providing a video graphic overlay having output fill data and output key data;

FIG. 2B is a schematic diagram illustrating an embodiment of a video graphic overlay device;

FIG. 3 is a diagram of a video graphic overlay device for use in video graphic overlay;

FIG. 4A illustrates a RGB graphic layer on a blank background;

FIG. 4B illustrates a black and white mask layer on a blank background;

FIG. 5A illustrates a video still with a graphic overlay produced from an output fill and key overlayed on top of a background camera source;

FIG. 5B illustrates the same video still as FIG. 5A with a different graphic overlay produced from an output fill and key overlayed on top of a background camera source;

FIG. 6 is a flowchart illustrating data input and output from to an interpolation engine;

FIG. 7 is a graphic overlay score bug comprising a template from a graphic library and incorporating input data;

FIG. 8 illustrates the graphical user interface on a video graphic overlay device with a selected video graphic overlay on a video stream;

FIG. 9 is a diagram illustrating multiple graphic overlay devices connected to a channel controller;

FIG. 10 is a flow chart illustrating the compositing of data and synchronization of a graphic element with a broadcast video using a timecode;

FIG. 11 is a diagram of a system for video graphic generation on a peripheral viewing device;

FIG. 12 is a front view of a graphic overlay device showing the display screen;

FIG. 13 is a top view of a graphic overlay device with data and power ports; and

FIG. 14 is a perspective view of a graphic overlay device.

### DETAILED DESCRIPTION OF THE INVENTION

Unless defined otherwise, all technical and scientific terms used herein have the same meaning as commonly understood by one of ordinary skill in the art to which this invention belongs. Working examples provided herein are considered to be non-limiting and merely for purposes of illustration.

As used in the specification and claims, the singular forms “a”, “an” and “the” include plural references unless the context clearly dictates otherwise.

The term “comprise” and any of its derivatives (e.g. comprises, comprising) as used in this specification is to be taken to be inclusive of features to which it refers, and is not meant to exclude the presence of any additional features unless otherwise stated or implied. The term “comprising” as used herein will also be understood to mean that the list following is non-exhaustive and may or may not include any other additional suitable items, for example one or more further feature(s), component(s), and/or element(s) as appropriate.

As used herein, the terms “having,” “including” and “containing,” and grammatical variations thereof, are inclusive or open-ended and do not exclude additional, unrecited elements and/or method steps, and that the list following is non-exhaustive and may or may not include any other additional suitable items, for example one or more further feature(s), component(s) and/or element(s) as appropriate. A composition, device, article, system, use, process, or method described herein as comprising certain elements and/or steps may also, in certain embodiments consist essentially of those elements and/or steps, and in other embodiments consist of those elements and/or steps and additional elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to. The recitation of ranges herein is intended to convey both the ranges and individual values falling within the ranges, to the same place value as the numerals used to denote the range, unless otherwise indicated herein.

The use of any examples or exemplary language, e.g. “such as”, “exemplary embodiment”, “illustrative embodiment” and “for example” is intended to illustrate or denote aspects, embodiments, variations, elements or features relating to the invention and not intended to limit the scope of the invention.

As used herein, the terms “connect” and “connected” refer to any direct or indirect physical association between elements or features of the present disclosure. Accordingly, these terms may be understood to denote elements or features that are partly or completely contained within one another, attached, coupled, disposed on, joined together, in communication with, operatively associated with, etc., even if there are other elements or features intervening between the elements or features described as being connected.

As used herein, the term “video input” encompasses any visual input data that creates a visual data stream for viewing. The video input is generally comprised of a series of visual or graphical frames that, when put together one after the other in time, make up a visual video presentation. In a digital video input, each frame comprises an array of pixels or voxels which can have a variety of assigned sets of channels, such as, for example, color or wavelength channels, and alpha channels. The video input can be data acquired, for example, from one or more cameras, such as physical cameras, virtual cameras, or a combination thereof, animations, and can comprise live and/or stored video, and can be of a real life, animated, or virtual scene.

As used herein, the term “video” refers to any image data stream comprising a plurality of images connected in time. The image data stream in a video can comprise one or more of photographic, animated, holographic, voxel-based or volumetric data, or any other kind of visual image.

As used herein, the terms “graphic element” and “video graphic” refers to a visual or graphical image that can be overlayed onto a video stream. The graphic element optionally comprises one or more data fields that can be populated by a data stream.

As used herein, the term “graphic library” refers to a memory storage having a plurality of graphic elements available for selection and/or an algorithmic or artificial intelligence engine to generate a graphical element.

As used herein, the terms “timecode” and “timestamp” refer to the metadata in a video pertaining to the clock, where the clock advances with the sequence of frames in the video. The “timestamp” refers to the timecode associated with an exact frame number in a video stream at a specific moment in time.

Herein is described a device and method for applying a graphic overlay onto a video stream. The present device and method can be used for multi-media integration in on-demand and live broadcast technology, as well as for non-live or pre-produced video processing. The present device and method provides broadcasters and video producers a way to enhance their multi-media capabilities and program quality while improving speed, robustness, reliability, and efficiency, and is particularly useful during live broadcasts. The present graphic overlay device can create a graphic image comprising time-specific data that can be synchronized with video and audio. A data field or data-mutable component in a video graphic overlay can be populated with data input relevant to the video at or near the time identified by the timecode, and the video graphic overlay can be combined with a high resolution video stream using a synchronization device to provide a high resolution multi-media video produced with enhanced graphics. The video graphic overlay and the graphic image can also be prepared with a transparency channel which can be combined with the video stream either internally, or using an external production device. This provides broadcasters and video producers a way to enhance their multi-media capabilities and program quality while improving speed, robustness, reliability, efficiency and story-telling capabilities, particularly during live broadcasts.

The graphic overlay device enables integration of live broadcast media streams with visual graphics that is smaller, portable, and more robust than currently used technologies. In addition, the presently described graphic overlay device has a pared down technology complement such that it can be isolated from the internet. This can enable faster access to required applications such as databases and graphics integration which results in more rapid and reliable data integration to produce a more stable and error-free graphics enhanced video stream. Many new graphics platforms and technologies such as those based on HTML5 are configured to run on cloud technologies, however the use of cloud storage necessarily delays data processing compared to local systems. The present technology lends itself not only to streamlining and simplifying professional live broadcast production, but also to simplified production of high quality amateur live broadcast. Professional graphics capabilities such as that provided by the present device and method are also desirable for lower budget productions, such as social media video production, amateur sporting, and amateur live events.

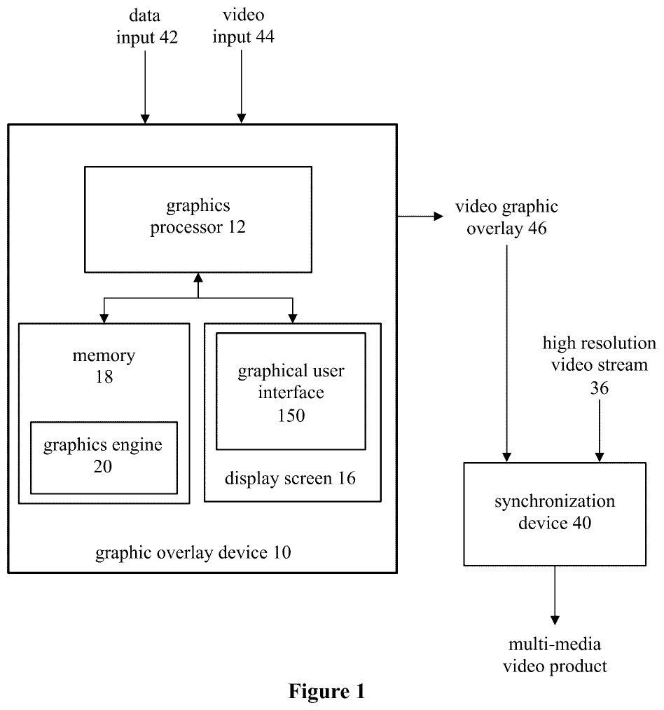

FIG. 1 is a schematic diagram illustrating an embodiment of a graphic overlay device for providing a video graphic overlay. Graphic overlay device 10 comprises a graphics processor 12, a memory 18 comprising a graphics engine 20, and a display screen 16 which displays graphical user interface (GUI) 150. The graphics processor 12 can further comprise or further be connected to a video buffer, which can also be referred to as a frame buffer or video RAM (VRAM). Video input 44 from a video data stream is received to the graphic overlay device 10 through a video input port, which can be, for example, an HDMI port, or an SDI port. There are many bandwidth speeds common for SDI (e.g. 1.5 Gbps, 3, 6, 12 and 18). Video is also commonly transferred using mediums and standards such as HDMI, SDI, DVI, and IP (network/ethernet port), and analog forms of video transfer such as VGA and S-Video. The video stream entering through video input 44 can be high resolution video or lower resolution relative to a high resolution video stream suitable for broadcast. Receiving a lower resolution video stream to the graphic overlay device 10 reduces the required memory, processing, and energy requirements of the device and increases the overall processing speed of creating the data to apply a graphical element overlay. A video buffer optionally in the graphics processor 12 is a form of a computer's physical memory that is used to store video or graphics information as it moves from the renderer (video card or CPU) to the display screen or monitor. As with buffers in general, the video buffer is used to organize data and to ensure that the data is efficiently moved from their source to their destination. The video buffer can also be used to quickly “rewind” video to go backwards in time to a previous location in the video, or to “delay” a video feed that needs to be synchronized with additional video, audio or data feeds. The video buffer can also retain audio and metadata along with each frame of video.

In an embodiment, graphics engine 20 contains a library of graphic element templates that may be selected for insertion onto a video broadcast or final production video stream. The graphics engine may, in addition to or instead of a graphic element library, comprise an image generation artificial intelligence (AI) component capable of generating a graphic element template based on input to the image generation AI. Input to the image generation AI component can come from, for example, text, audio, video, a data stream, or a combination thereof. Each graphic element template preferably contains a color channel such as RGB or alternative color space, and an alpha channel (A) which contains transparency data, the sum of which is an element with RGB+A components. In contrast, most current technologies for transmitting video only handle the color channels and no alpha channel. In some embodiments of the present system, the output fill contains the color data (RGB) transmitted on its own, and the key contains the transparency data (A) transmitted on its own, either as a black and white or a greyscale image. Each graphic element template can also optionally contain fields or variable regions that can be filled in with data, either entered by a user of the graphic overlay device 10, from database data, or from the data input 42. Data input 42 can receive data through one or more channels through an interface port, such as, for example, a serial digital interface (SDI) metadata, timecode, serial data on a DB9 port, IP data via an Ethernet port, GPIO or sensor derived data. An SDI interface can provide either compressed or uncompressed digital video signals, multiple channels of audio, and metadata, using a 75 Ohm coaxial cable.

The present device can render full color 2D and 3D graphics by providing output of a video graphic overlay, optionally comprising a fill and key, that can be recombined with a high resolution video stream using timestamp synchronization to produce a broadcast quality video product. The RGBA color space contains a combination of the red (R), green (G), and blue (B) light components of additive color along with the alpha component (A) representing the luminance or transparency information of an image. Fill and Key is a technique used to composite graphics in broadcast vision mixers where the output fill contains the graphic (i.e. color pixel data) content and the output key contains masking information. Physical video signals like HDMI (High-Definition Multimedia Interface) and SDI (Serial Digital Interface) do not carry alpha information. Therefore the alpha channel or output key needs to be split into a separate video signal from the RGB, or alternatively the YUV signal, where a color is described as a Y′ component (luma) and two chroma components, U and V which indicate locations on a two-dimensional color plane. To do this, the graphic data can be split into the color channel (fill) and the alpha channel (key) signals by sending the output fill and output key to two different video outputs.

To create a graphic element overlay a video is displayed on display screen 16 onto which the graphic element overlay is desired. A graphic element template is then selected from the graphics engine 20. The graphic element template can then be manually, automatically, or a combination of manually and automatically populated to customize and fill in the variable elements in the graphic element template. Customization of the graphic overlay can be done to accommodate the settings or nature of the video, the data input 42, and/or according to an applied settings template which can be separate from the graphic element template. In one example, a score bug graphic element template can be selected that has team icons and team colors based on two teams playing in a sports game in the video, and a settings template can be applied for each of the two teams playing to customize the score bug with the playing teams' colors and icons. GUI 150 displays the graphical elements for the user, including the graphic element templates, components from the graphic element library, settings templates, and final graphic element overlay for design, placement, and finalization. Once the graphic element has been customized, sized, and placed on the video on the GUI 150, graphics processor 12 converts the selected graphic element overlay into a graphic data stream which contains video data in the form of a pixel stream from a video buffer that defines the size, outline, pixel color, and location of the graphic element overlay, as well as the video stream timecode or timestamp on the video stream timecode of when and for what duration the graphic element overlay should be applied to the video. The video graphic overlay 46 and video stream timecode or timestamp are then sent as an output data stream to a synchronization device 40 which comprises a graphics processor to combine the graphic element overlay with a high resolution video stream 36 suitable for broadcast or final production. The result is a multi-media video product with a high resolution video stream combined with one or more graphical overlays. The video graphic overlay can be synchronized with the high resolution video stream 36 with one or more timestamps from the video stream timecode. If the high resolution video stream is a playback (i.e. not live), the graphical overlays will contain data from the exact moment the video was captured, so that the data is in perfect synchronization with the video and audio. These graphic overlays can be adjusted after-the-fact, to present the data in the most relevant way for the viewer, or most expressive way for a specific story to be crafted by the content producer.

In some forms of broadcast, the broadcast product is a single output video stream with all of the applied graphical overlays incorporated into the image. In this way, all viewers of the broadcast will receive the same broadcast video stream. In use of the present system, by separating the video stream and the graphic overlay stream, the final broadcast image can be modified to suit each viewer of the broadcast stream by changing the graphical elements to suit the user and enhance the viewing experience. Tailoring the received broadcast for the user may include, for example, changing the text size or font for displayed graphic elements, switching between dark mode and light mode for viewing, selecting certain geolocational specific data pertinent to the viewer location, and overlaying enhanced graphics onto the video stream for improved accessibility for the viewer.

The present graphic overlay device 10 can be used in conjunction with other television broadcasting professional tools such as audio and video capture devices to, for example: encode video to disk; decode saved videos to SDI or IP streams; convert between SDI and IP streams; output real time graphics renderings with independent fill and key signals; lock output video signals to a reference signal; receive commands and/or triggers from external devices via RS232 and RS485 using protocols such as peripheral bus (PBUS); send and receive triggers to external devices via simple GPIO contact closure; audio, video and data routing; and as a general purpose computer. The video stream can also include an audio stream.

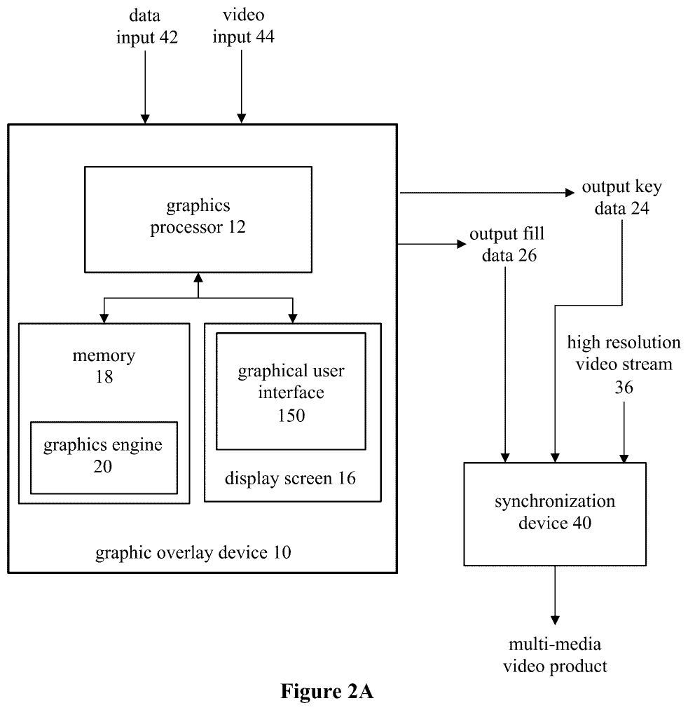

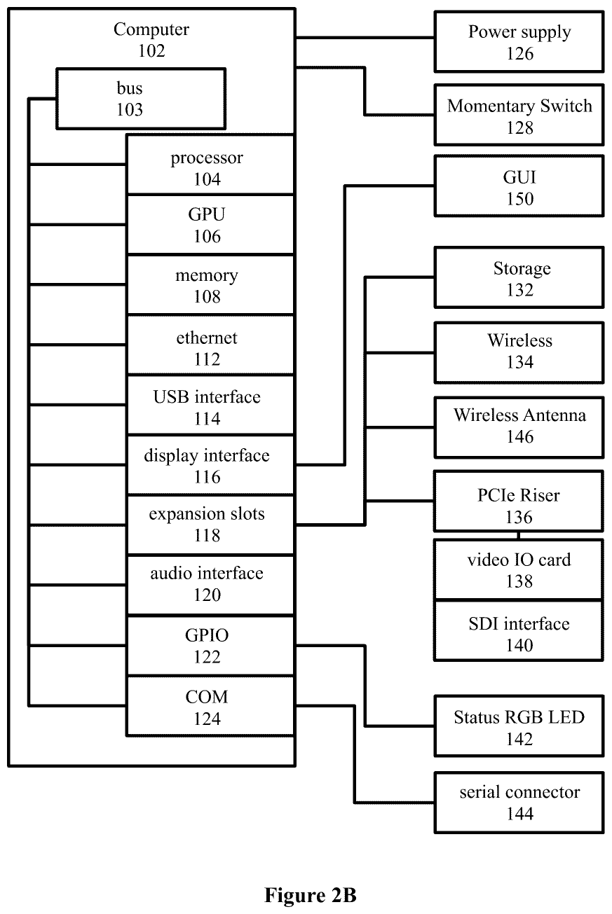

FIG. 2A illustrates an embodiment of a graphic overlay device for providing a video graphic overlay having output fill data 26 and output key data 24. Graphic overlay device 10 comprises a graphics processor 12, a memory 18 comprising a graphics engine 20, and a display screen 16 which displays graphical user interface (GUI) 150. The graphics processor 12 can further comprise or further be connected to a video buffer, which can also be referred to as a frame buffer or video RAM (VRAM). Video input 44 from a video data stream is received to the graphic overlay device 10 from a video data port, which can be, for example, an HDMI port, or an SDI port. Data input 42 can receive data through one or more channels through an interface port. In the embodiment shown in FIG. 2A, the output fill data 26 can be sent as a separated data stream from the output key data 24. The video graphic overlay can be manipulated by the graphics processor 12 to convert the selected graphic element overlay into a graphic data stream comprising an output data stream comprising an output key 24 and output fill 26 as two separate data streams. These two separate data streams can be combined downstream with a high resolution video stream 36 at a synchronization device 40 during video production to provide the video graphic overlay on a multi-media video product.

FIG. 2B is a schematic diagram showing a hardware description of a video graphic overlay device, according to one embodiment. A video graphic overlay device includes a computer 102 which has a bus 103 or other communication mechanism for transferring data between components, and a processor 104 coupled with the bus for processing information. The computer 102 also comprises a memory 108, such as random access memory (RAM) or other dynamic storage device (e.g. dynamic RAM (DRAM), static RAM (SRAM), and synchronous DRAM (SDRAM)) coupled to bus 103 for storing information (which may include temporary variables or other intermediate information) and instructions to be executed by processor 104. Memory structures such as registers for storing temporary variables or other intermediate information may also be included in processor 104. Computer 102 may also include a cache memory coupled to processor 104 for storing and providing faster access to frequently used data. Computer 102 further includes a read-only memory (ROM) or other read-only storage that may include but is not limited to programmable ROM (PROM), erasable ROM (EROM), and electrically erasable ROM, coupled to the bus 103 for storing read-only information and instructions for the processor 104.

Computer 102 also comprises a display interface 116 coupled to the bus 103 to control a touchscreen user interface (UI), such as, for example, a liquid crystal display (LCD) or an embedded display port (eDP) touch display, for example for receiving input from and displaying information using a graphical user interface (GUI) (150) to a computer user. In another embodiment, a touchscreen UI may be replaced by a different display type such as a light emitting diode (LED) screen, LCD, or other device suitable for displaying information to the user, as well as one or more other input devices for receiving user input such as, for example, one or more keyboard, touchpad, mouse, or other devices including external or remote devices in communication connection with the computer 102. The communication connection can be hardwired, or wireless, for example by Bluetooth, cellular, Wi-Fi, or other wireless connection.

Display interface 116, which may include an embedded display port (eDP) interface, is connected to a graphics processing unit (GPU) 106 for processing graphics-intensive operations or other highly parallel operations. Operations processed by the GPU 106 may include but are not limited to rendering graphics to the display interface 116, to the PCIe SDI I/O interface 140, encoding and decoding video to and from compressed formats, converting video to and from IP streams, conversion of video frames to different color spaces, and to overlay multiple graphics or video sources into a combined output. Enabling the GPU 106 to perform these types of graphics processing operations accelerates the processing of these energy and processing intensive operations and improves the overall performance of computer 102. Newer GPU chips have hardware built-in for encoding and decoding videos into compressed formats. Encoding and decoding high resolution video streams to compressed formats is an extremely intensive operation, so offloading this to the GPU frees up the CPU and improves overall efficiency of the computer. The GPU 106 may also comprise its own dedicated video memory (VRAM) for storing data such as, for example, graphic element templates and rendered graphic elements, generated during its operations. Software for the system can be written with modern high-level tools, for example a video game engine, that are capable of cross-compiling to multiple platforms with support for many types of hardware. The present system can also offload intensive video tasks to the GPU such that video frames can be moved quickly in and out of the video buffer.

Computer 102 is also connected to a plurality of data ports or data interfaces in the graphic overlay device for receiving external input data and sending output data. These data ports can be connected to one or more external computers, cloud computers, digital cameras, or other computing devices, including to the internet, information storage devices, or other sources and destinations for information that are connected to bus 103. The plurality of data ports may include but are not limited to one or more of an ethernet interface 112 (e.g. one or more RJ45 ports) for connecting to the internet and other external data sources, a USB interface 114 which may be but is not limited to one or more Type-A, Type-C or other USB interfaces in any combination, and an optional audio interface 120 for audio input and output which may comprise one or more of a microphone and/or headphone connection. Optionally, the wired ethernet interface or other wireless communication interface can be connected to a network such as the Internet, an intranet, a cloud network, or any other network suitable for searching, obtaining, and/or using information and/or communications. Other external data port interfaces may include but are not limited to one or more High-Definition Multimedia Interface (HDMI) ports for data input and output which may include but is not limited to audio and/or video input and output, power (e.g. a DC jack), and a micro SIM card slot for accessing stored information on SIM cards. Data may also be sent and received by serial communication via, for example, RS232, RS422 or RS485. The serial ports may be on a standard DB9 connector or a custom wired connector such as a specialized RJ45 port. GPIO data can also be sent and received via these types of ports and pins as well, either on a DB9 connector or custom RJ45.

Computer 102 can also comprise one or more M.2 type expansion slots connected through bus 103 to allow additional capabilities, for example these expansion slots can allow additional forms of communication to add Wi-Fi radios, Bluetooth, GPS or GNSS receivers, LTE or 5G modems, or expansion of the PCI bus. Using a specialized M.2 to PCIe adapter allows connectivity to high-speed PCIe cards, for example but not limited to SDI video input and output PCIe cards. Other interfacing devices may be used, for example but not limited to one or more Serial ATA (SATA) ports, peripheral component interconnect (PCI) ports, small computing system interface (SCSI) ports, parallel ATA (PATA) ports, as well as cloud-based device interfaces. Another common interfacing technology that may be used is Thunderbolt, which is similar to USB, but extremely fast with some additional capabilities and allows for high-speed external devices to be connected over long distances. Expansion slots can be used to, for example, add one or more of storage 132 for storing data and instructions, such as a solid state drive (SSD) or other external storage device, a wireless interface 134 for a Wi-Fi module that adds wireless, Bluetooth®, and/or Wi-Fi input and output capabilities, a wireless antenna 146 for upgraded wireless signal reception that may include Wi-Fi and Bluetooth® and other types of wireless signal. In addition, one or more video IO cards 138 can be used to add additional audio and/or video interfaces connected to computer 102 through an expansion slot. In this embodiment, video IO card 138 comprises a serial digital interface (SDI) 140 for connection to SDI audio and video input and/or output. In one example, computer 102 can be connected to a plurality of independent mini SDI connections. Video IO card 138 may also be connected through an adapter such as a PCIe Riser 136 to an M.2 expansion slot.

Computer 102 also includes a connection to a power supply 126, which is optionally controlled through a momentary switch 128 for powering on the device, or triggering a shut-down or sleep. Power may be supplied by a power supply unit that converts mains AC to low-voltage regulated DC power, an electrochemical battery, or other power source, or may be an external power supply. Computer 102 also comprises internal input and output interfaces that are connected through bus 103, such as, for example, interfaces for one or more of power, reset, one or more power status LED, hard disk drive (HDD) status LED, high definition audio, line-out, mic-in, USB interfaces, a fan connector, a SATA connector for connecting bus 103 to mass storage, streaming, or other devices including one or more general-purpose input/output (GPIO) 122 for software controlled input and/or output, and communication port (COM) 124 for serial data connection. In the shown embodiment, one or more serial connector 144 such as RJ45 or DB9 are connected through COM 124 for connection to external sources of serial data. Computer 102 can also comprise one or more expansion slots 118. Optional status RGB LED 142 is connected through GPIO 122 and can be controlled through software to display. In an embodiment, RGB LED 142 can be an array of RGB LEDs which can change color or make animated patterns to indicate the status of the device status, where the status can be, for example, recording, streaming, shuttling video, receiving data, or just indicating the system is operational. The LEDs can be controlled via software and input/output to the GPIO 122 and serial data is available for communication with external devices. Other optional features can include one or more fans inside the device for temperature control and a thermostat for measuring the internal temperature which can be used as feedback to control operation of the fan or provide an overheat warning. Through a video data stream connection, such as one of the interface ports through bus 103, computer 102 may be provided with video data that has been pre-recorded (e.g. from storage 132, from an internet source of audio and/or video, from the cloud or other repository of recorded data, or may be in communication with live broadcast or streaming equipment that transmits content in real time from an event of interest. The graphic overlay device and components are preferably mounted in a protective case for easy transport and to provide protection to the sensitive components therein. Alternative embodiments, devices, connections, and configurations of data handling components and elements may be also used in the graphic overlay device as described herein.

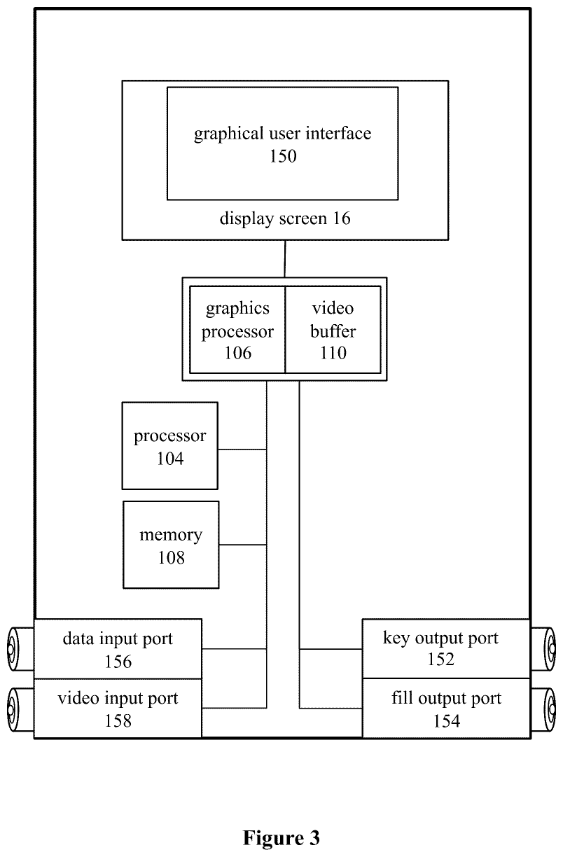

FIG. 3 is a schematic diagram of hardware in a video graphic overlay device for use in video graphic overlay. In an embodiment, the presently described graphic overlay device is a portable, all-in-one computer in a box for general purpose use in applying visual graphic overlays onto video that can be used in television, network, and live and pre-produced broadcasting applications. The graphics processor 106 is used to create the graphic element overlay for the video together with video buffer 110 and also reduces the load from the central processing unit or processor and generates a data stream of graphics output to graphical user interface (GUI) 150 on a display screen 16, which is optionally a touch screen. Preferably the data input port 156 and video input port 158 are connected to a peripheral component interconnect express (PCIe) card for input and output of SDI signals in, for example, one of 1080i59.94, 1080p59.94, or 2160p59.94 format, to and from professional broadcast equipment. The PCIe card can be used for input and output of SDI signals as well as for both input video and output video through, for example, key output port 152, fill output port 154, and video input port 158. The data input port 156 may receive a form of data, such as via serial or ethernet (TCP/UDP) or another protocol. Another signal that is received by the PCIe card is the reference signal, which can be connected by a BNC connector but is an analog reference signal for timing purposes. The most common reference signals in television broadcasting are called “Tri-level” and “Black Burst”. If the reference signal is connected, the output signals from the key output port 152 and fill output port 154 can be timed exactly to the input reference signal, allowing them to easily connect to other equipment that shares the same reference signal.

The graphics processor 106 is connected to a main processor or CPU that can run a processing language, such as for example Linux, from a storage drive. The CPU can be part of a computer with one or more additional input/output and/or processing devices, including integrated or peripheral storage, communication, or memory devices for communicating with external hardware via general purpose input/output (GPIO) and serial. The computer can also optionally have wireless (e.g. Wi-Fi, Bluetooth®, and cellular) capabilities. Display screen 16 can be a touchscreen and can be connected to one or more additional keyboard, mouse, touchscreen, or connection to a peripheral computer component connected to or comprising the same. In one embodiment, the display screen 16 can be a high-resolution touch-screen which can display an interactive graphical user interface (GUI) 150.

In a hardware device, the data input port 156 and video input port 158 as well as the key output port 152 and fill output port 154 can be hardwired ports. Preferred connector types for the data input port 156 and video input port 158 as well as the key output port 152 and fill output port 154 are SDI video ports (e.g. BNC, mini BNC, micro BNC, etc.) and HDMI connector ports (e.g. standard (type A), mini (type C), and micro (type D)). Preferably, the present device uses high durability BNC connectors which are more robust and reliable than other data port types.

The processor 104 and memory 108 may additionally comprise one or more components such as a storage device for storing an operating system and one or more application programs and their data, a network interface unit, and/or an input/output controller connected through at least one bus. The device can also comprise an integrated power supply and/or battery. In use in a broadcast production environment, the present device will preferably be designed to be resilient to movement, preferably with a protective case to enable set-up and tear down of the production facility in a rush and stacked among other equipment during transport. A back hatch on the protective case can provide access to the computer components so that components can be quickly swapped out if necessary for quick technical support, for example swapping out a storage device or solid state device (SSD) if there is a malfunction or update with the software. The graphical overlay device is designed to be used in a climate-controlled television control room with good ventilation and dim lighting, however is preferably robust enough that it can be used in outdoor and more variable environments. For large productions, multiple devices may be used in tandem to provide more than one graphical overlay onto a single video or multiple videos. The present device does not need an internet connection and can operate independently of internet with all required software and graphic templates stored locally. This network isolation reduces call times to software as there are no internet communications or cloud communications requirements to retrieve graphics templates or data for template population and customization. Additionally, all software required for creating and customizing the graphical overlays can be created and stored on the device.

The system of the present invention further includes an operating system installed and running on the hard drive, enabling the device to communicate through network with remote, distributed devices, networks, data storage systems, and data analytics systems. The operating system may be any operating system known in the art that is suitable for network communication as described. Data storage may house an operating system, memory, and programs. It is notable that the present device does not require an additional operating system and can operate on a Unix-like operating system such as Linux. Software can be locally uploaded, stored, and maintained as is without external update or modification, which enables a stable data source for an individual operator to store their software, macros, settings, modifications, etc., which is especially important in a high speed environment such as live broadcasting. The present device provides a pared down technology which is fast and easy to use, portable, and enables both a lower price point and increased accessibility to non-professional broadcasters such as people who produce video for social media, amateur and community sports and arts events.

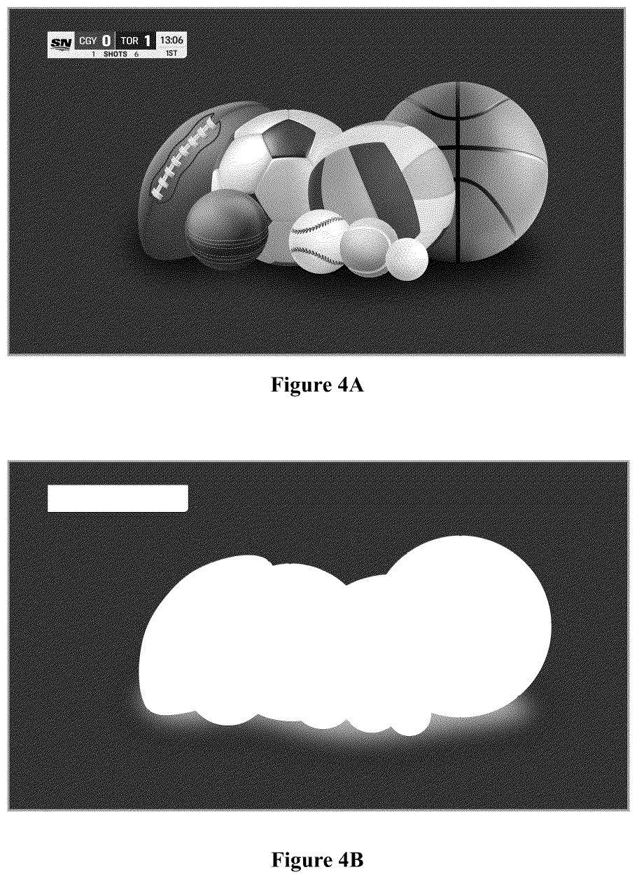

FIGS. 4A and 4B illustrate an output fill and output key, respectively, for a graphic overlay, where 4A illustrates a RGB graphic layer on a blank background and FIG. 4B illustrates a black and white mask layer with a transparency shadow on a blank background. Visual media streams that can provide a graphic element overlay for applying to a video stream come in various types, including but not limited to telestrator graphics, clock and score, chyrons, tickers, static graphics, augmented static graphics, and augmented video effects or animations. A telestrator graphic is a graphic element created by a telestrator which can be overlayed onto a video stream. A telestrator can be used to manually or automatically draw one or more lines or symbols to illustrate aspects of the video stream, for example to identify a moving object such as a player, vehicle, or ball, and follow the movement of the moving object over time. The telestrator graphic can comprise drawn and/or graphical text describing the video, and the graphic element created by the telestrator can be independent of the video stream data, but overlayed at a matching clock time after production. In sports, the telestrator is often used in conjunction with instant replay to diagram and analyze a recent play. A score bug, also referred to as a clock and score, is a graphic element which displays the game score and/or current time and/or time/clock in game in a graphic overlay on a video stream. The score bug usually comprises a graphic element or icon which has an embedded data field which is updated based on the data input, such as the score, time, or time in game or period. Other graphic elements include lower thirds, also referred to as a chyron, are terms for the graphics that are in the lower ⅓ of the screen to identify somebody's name and info, such as providing a name and organization of a talking head or presenter on a screen. A chyron, also or “lower third” is a digital, text-based graphic in the lower third of a TV news display, lower third template, or text and/or graphic displayed on the screen to identify a person, organization, etc. A graphic element can also include full-page graphics which are graphics that occupy the whole screen. A ticker is a strip or stripe, usually providing news updates or other information as textual data stream, and sometimes presented on a graphical or colored background. A static graphic or augmented static graphic is image data applied to video features that are pertinent to the video. In an example, a static graphic can be applied to football yardage lines if these are not already visible in video (for example if they are obscured by snow), a football first down line, applied advertising to components in the video (e.g. to boards in hockey, an ice surface, field surface, etc.).

Other graphic elements can include augmented reality (AR) graphics that are optionally motion tracked with a camera movement, charts, graphs, and graphical advertisements. An augmented reality graphic can be used, for example, as a player or ball tracking graphic, for example as an arrow and player name identifier that travels with player on field/ice, and as a puck identifier with a direction and speed of travel. An augmented video effect or animation can be a dynamic video effect applied to the video for immersive, augmented reality effects, for example for use as a graphical filters (e.g. a filter on a hockey puck with trailing colors and effects, a car outline with trailing fire and sparks), and other applied graphics such as goo or makeup applied to players or audience, fireworks displays, and other overlayed animation optionally based on video, animal graphics (e.g. team mascot jumping all over stadium in video), holes in field, 3-D volumetric graphics, other applied graphics and animation.

Each graphic element template comprises a graphic element whose attributes can be changed based on the sampled data from the data stream, which is incorporated into the graphic element template to provide a video graphic overlay. In one embodiment the graphic element template can have a border which may be comprised of a standard frame with graphic or logo and can optionally have one or more fields that can be populated from a data set or data stream. In another embodiment the graphic element template can be generated and/or modified based on the sampled data from the data stream. In an example, the sampled data may be a single data point such as the current temperature or current score, and a graphic element overlay can be created from a graphic element template inserting the temperature or score. In another example, the graphic element overlay can be changed to reflect the sampled data, such as showing snowflakes when the temperature is low, and sunshine when the temperature is high. In an example where interpolated data is used as the sampled data, such as a player average speed over time, a graphic element can be generated displaying the interpolated sampled data of the player average speed along with a graphical image of the player.

The graphic overlay template is also generally accompanied by a related background which blocks out or changes the transparency or colour of the video stream at the location of the template so that the template can be overlayed with the desired visual effect. Graphics templates are often branded with a team, network, organization in advance to provide visual coherency and uniqueness to the broadcast. The data stream can provide data for the graphic template, including, for example, team identification, color, logos, player identification, location of objects, players, game ball, speeds of objects or players, statistical information from sensors, statistical information from statisticians, fan derived data, voting data from a poll or app, and predictive data based on a pattern or artificial intelligence (AI) model. The larger (i.e. bitwise) the graphic, the slower the download speed from an external source if the graphic must be obtained from an external source. To broadcast more intricate and better graphics and not affect the broadcast delay it is therefore desirable to have the graphics templates accessible and local.

FIG. 4B illustrates an output key for a graphic overlay. The output key for a graphic provides information on the outline and the transparency of the output fill. Both the output key and the output fill are synchronized and combined with the finalized high resolution broadcast video stream to provide a final high resolution broadcast production complete with high resolution graphical element overlays. In one embodiment the fill and key are fed into a TV production switcher that can layer the fill and key on top of the high resolution uncompressed video. In another embodiment a video buffer connected to or integrated with the present system can also enable combination of the output key and fill. A buffer may be used, for example, if the incoming video needs to be delayed slightly so it is in time with rendered graphics. In particular, a computer rendering can result in at least 1 frame of delay before the output fill and output key are produced.

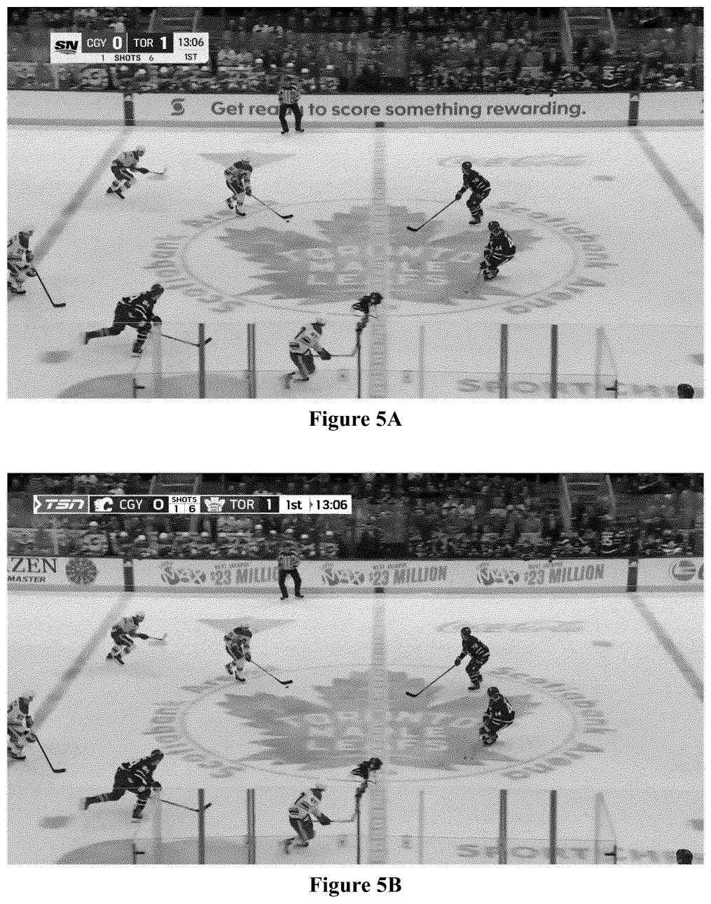

FIG. 5A illustrates a video still with a graphic overlay produced from an output fill and key overlayed on top of a background camera source. FIG. 5B illustrates the same video still as FIG. 5A with a different graphic overlay produced from an output fill and key overlayed on top of a background camera source.

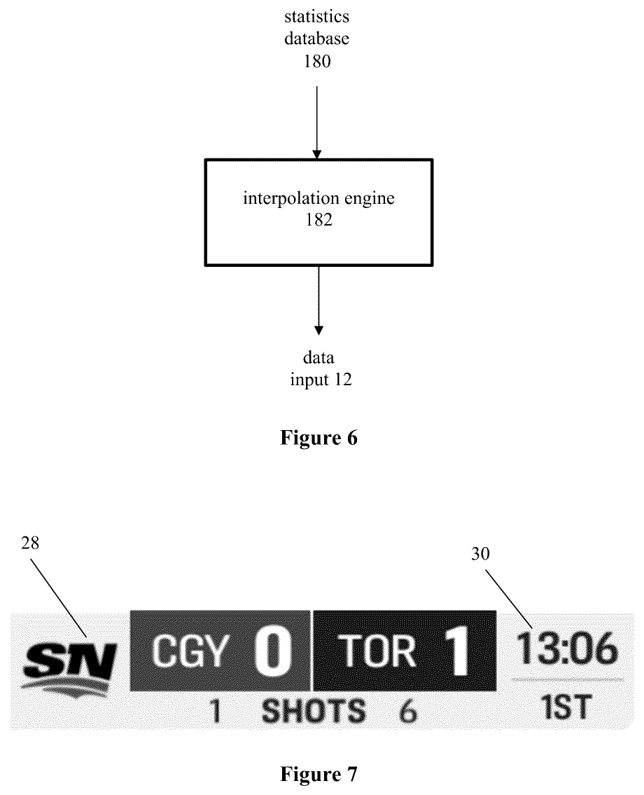

FIG. 6 is a flowchart illustrating one example of data input and output to and from an interpolation engine 182, where data interpolation between samples of data input can be done in real time. Data input can be a continuous stream that is sampled along with the video, or data can be captured in its entirety without sampling. Data obtained from a data input stream can be periodic or sporadic. Specifically, data can be sampled at specific intervals or sampled with a specific data call from a historical data set, real time data set, or generated data set. In the case where data is not continuous with the video stream, such as data gleaned from a historical data set or statistics database 180, recalling the value of a data point at a specific timecode can require interpolating from data points close to the timecode. With data being captured in real time, such as data pertinent to the video stream, also referred to as real time data, the values of the data received can be added to a database such as statistics database 180 that records the exact time or timestamp or range of timestamps for which the data value(s) was sampled. When a value at a specific time is requested, an interpolation engine 182 can analyze the data and return an interpolated result between previously sampled data value(s) and the next sampled data value(s), and send those interpolated data fields to the graphics processor 12 as data input. The more data samples that are captured that are used for data interpolation, the higher the resolution and accuracy of the interpolated result.

There are various algorithms for calculating the interpolated result, and these can be selected and/or adjusted separately for each data field based on the type of data being represented in the data stream for the graphic element overlay. For example, a clock being sampled may be represented by a linear interpolation, whereas the speed of an object, such as a player on a field or a ball in flight, may use a Bezier interpolation. More complex algorithms may also be used to predict values before they are sampled, or use pattern recognition to hypothesize values in a low resolution capture. In a specific example, player tracking using an x, y coordinate system on the ice in a hockey game can be internally generated based on computer vision, or externally generated from external sampling, or both data streams can be put together to interpolate an expected future player movement. Incorporating external data and statistics for sports teams and players is of great interest during live broadcasting and presenting interpolated real time data enhances the viewing experience for sports enthusiasts. Integration of statistics databases with AI to detect interesting patterns and provide statistics that can be easily delivered to viewers is expected to increase in popularity for broadcasters to draw viewers. Some examples of enhanced data include player performance over time, in particular conditions such as against a certain team, trends of players/teams over time, etc. Enabling display of emerging interesting statistics in a live broadcast requires complex pre-built graphics templates that can rapidly receive and display this new data and can use either locally stored or input stream of statistics data that can be used for the live broadcast for input into graphics.

Telemetry and other data including real world telemetry can also be collected during the game and used to provide new and interesting data that is available for broadcast. This can further provide new data streams and new applied graphics, such as virtual overlays of vehicle travel lines, transparent overlay of other vehicle performance, player movement overlays including limb locations, and current statistics (e.g. speed, time deviation from competitors, graphical representation of acceleration/throttle in a split screen, etc.) In addition, obtaining telemetry x,y,z coordinates of player and ball locations enables tracking and broadcast of individually selected players and moving objects. Other physical metrics may be used in combination with telemetry and prior data, such as, for example: player and/or vehicle speeds, distances travelled, or time on ice/court/field; post-game performance reports showcasing a player's impact on the game; and heat maps and advanced visuals showcasing player positioning and offensive or defensive efficiency. Visualizations of the data can help explain a player's performance over time, for example, illustrating a bar chart of a player's average speed per game across his or her past ten games could indicate an improvement or potentially validate an injury. Graphs could also be used to extrapolate the data, to indicate trends or patterns. Using AI, the telemetry data could be analyzed to produce more complicated patterns, such as a team's performance in different time zones or different climates, or head-to-head match-up predictions between teams or players.

FIG. 7 is a graphic element overlay score bug comprising a template from a graphic library and incorporating input data. The graphic element shown is typically referred to as a score bug, or clock and score, and provides an indication of one or more of the teams playing, game score or points scored by each team, and/or current time and/or time/clock in game in a graphic overlay on a video stream. The graphic element optionally comprises one or more data fields that can be populated by a data stream or local data. For the score bug shown, the graphic overlay device can either receive an indication of the teams playing from an input from the user or from the data input stream. Similarly, the device can store team colors and icons for display on the score bug. In the shown score bug for a hockey game, there is a static graphic element 28 field that can be populated with the network icon. A graphic data field 30 may also be used for team identification, here Calgary (CGY) and Toronto (TOR), as well as score fields next to each team, number of shots taken by each team, an identification of the period (1^{st}) and the number of minutes remaining in the period (13:06). All of these data fields can be supplied by the data input to the graphic overlay device to populate the output key for the score bug graphic element. In this example, the score bug has an output fill which contains the graphical elements, and an output key which provides the transparency mask per pixel of the output fill.

Other fields in a graphic element template can populate the graphic overlay with other data from the input data, such as, for example, weather at the location of the event, windspeed at the location of the event, temperature at the location of the event, time, date, etc. Information about players currently in the game, as well as the players who are not playing, the referees of the game, the attendance at the game, are examples of custom templates that can be built into the graphics with data populated from an external data source. Also, information about the broadcast, such as who is commentating, can be presented. Templates can also be built for custom advertisements, such as dynamic advertisements, for example, the current amount in the venue's 50/50 lottery jackpot to encourage fans to buy tickets. The customizable fields in a graphic overlay template can also populate from a statistics database, for example providing player name, number, history of what teams played with and when, scoring and play statistics, injury history, played game stats (e.g. coach present, weather during game, etc.) One example of statistics derived from a database would be how many games a player has played to date, their current age, their birthplace, etc. Statistics may also be derived from a search that queries a database, for example, finding how many times a goaltender has let in a shot from a specific location, or how many times a team has won or lost versus another team.

In other embodiments data input can be generated through a variety of AI techniques, such as processing data via a Large Language Model (LLM), generating historical information or statistics. This processing could be achieved either by processing locally on the device by loading the model into memory, or by using a model on the cloud through an API. Graphic element overlays may also be potentially generated using AI models for image generation such as, for example, Stable Diffusion, to create custom tailored graphics on-the-fly at the user's request, or could create a combination of AI generated graphics and data, including AI-generated formats and designs for visualizing data, such as through charts and graphs.

AI models that process either imagery or audio may also be used to recognize events in the inputs that can be used to either create the data feed, or to recall data from an existing data feed. For example, the model could extract highlights of a sporting event based on the commentators audio, crowd noise audio, director's microphone, or from other sensor input such as sensors on the field of play. Reactions to the events through these audio sources may then be assigned data points in the feed with a timecode, associating certain crowd or commentator reactions, sensor data, or various volume patterns or dialogs, with events in the video recording. AI models can use a still image or clip from the input video of the device to feed into an AI for upscaling, and then output an overlay of the upscaled result. AI models may also be used with various inputs, such as one or more of a still image, audio, text, sensor data, or clip from the input video, to generate a 3D model representing the visuals in the video's frame or field of view. AI models can also be used to extrapolate or augment by repositioning the camera from the original source imagery. Computer vision combined with AI may use a combination of video, audio, and data to suggest appropriate overlays or graphics to augment the broadcast. Statistical information pertinent to the story or video may also be automatically suggested and presented as an overlay, either live, or when the video is replayed at a later time. The same automatic information overlay may also be applied to one or more graphic overlay providing, for example, subtitles and/or closed captioning in various languages, optionally combined with live audio translation into multiple languages using a combination of speech-to-text and text-to-speech AI models.

Data input into a graphic element overlay can also optionally be taken from an interpolation engine which can provide new data correlations based on existing and/or variable data in the database and other input data. In particular, the interpolation engine can take data input and interpolate new trends, such as performance of a player in a particular weather condition, under a particular coaching structure, performance of a team in a particular city or at a particular time of year, etc. The interpolation engine can be used for estimating values of data at a particular moment between two samples of data. If the broadcast is replayed at a later date, a sensor data obtained of a player speed in a game or sport may only update once per second. Using the interpolation engine, the player's speed can be fairly accurately predicted at any point by inferring and deriving between recorded samples of data. The interpolation engine may also be used to extrapolate data, to predict trends over time.

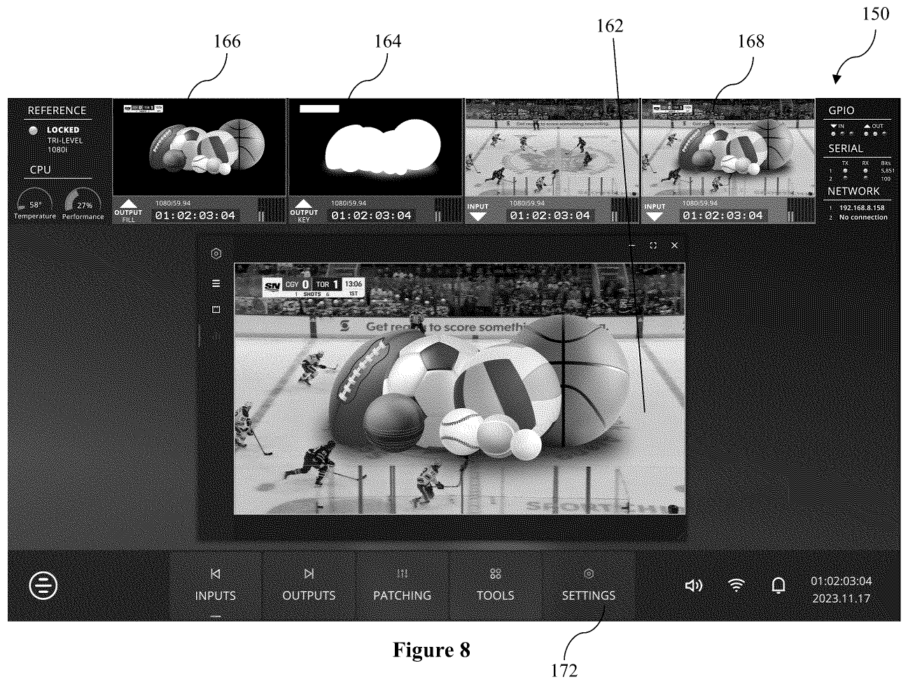

FIG. 8 illustrates the graphical user interface on a video graphic overlay device with a selected video graphic overlay on a video stream. The graphical user interface 150 can be provided on the display device of the presently described video graphic overlay device. The graphical user interface 150 provides a technician with a view of the broadcast video 162 on the video stream input to the device onto which a graphic overlay is to be placed. On the graphical user interface 150 is also displayed the output key image 164, the output fill image 166, and the combined graphic overlay image 168. Menu 172 on graphical user interface 150 provides access to functionality on the system.

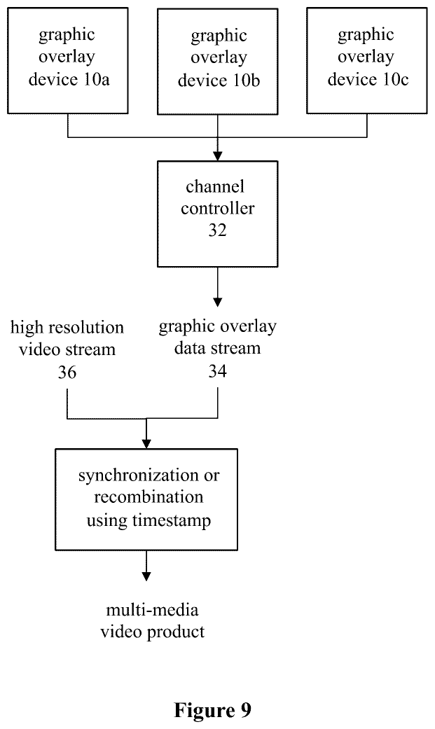

FIG. 9 is a schematic diagram illustrating multiple graphic overlay devices connected to a channel controller 32. A controller to select different channel feeds from different users for each timestamp range on video stream. In the embodiment shown channel controller 32 receives an output key and output fill from each of graphic overlay devices 10a, 10b, 10c. One or more of the graphic overlays from each device can be either selected and/or combined to provide a single graphic overlay data stream 34, which can then be combined and synchronized with a high resolution video stream 36 to produce a high resolution multi-media video product. To synchronize the timecode of the graphic overlay data stream and the high resolution video stream, the device will interpret and extract a timecode from the metadata of the high resolution video stream. This timecode for a video stream is usually produced from the device that recorded the video stream and is associated with each frame in the video recording. The device will read the timecode of the video input and synchronize the graphic element, data input to populate the graphic element, to match the recorded video data with the data input values at the timestamp position of the frame in the timecode. In one example, if the timecode from the input video stream were to slow down or freeze, the data would immediately slow down or freeze as well, resulting in the data input to the graphic element being perfectly in synchronization with the video input according to the timestamp. In another example, if the data input does not exist or was not recorded for the timestamp in the frame, the data may be interpolated using the data input from adjacent or close frames to the timestamped frame. Synchronization on a broader level uses a timecode, also referred to as a timestamp, which is associated with an exact frame number in a video stream. For example: 17:52:12:27 represents 5:52 pm at the 12 second mark, at frame #27 out of 60 in the second at a 60 Hz frame rate. If the video input is showing a frame of video with the timecode 17:52:12:27, data recorded in the same time as the recorded frame could then be used for data interpolation as relevant to that frame. When the video advances to 17:52:12:28, the graphic can be updated with additional interpolated graphics for that frame of video based on data gleaned in the relevant time period.

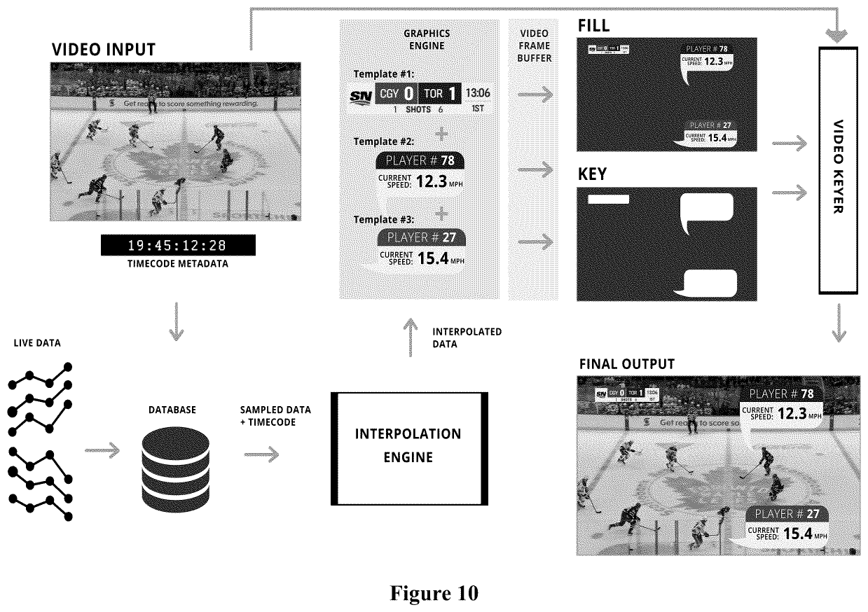

FIG. 10 is a flow chart illustrating a method of compositing of data and synchronization of a graphic element with a broadcast video using a timecode. Live data is first recorded in a database along with the current time of day, which represents the current “timecode”. The high resolution video stream is playing previously recorded video, and the timecode is being recognized by the system as metadata accompanying the video feed. A graphic element or graphic template or templates is selected which includes an identification of relevant data to be displayed in the graphic element that coincides with the previously recorded video. It is noted that “recorded video” can refer to video stored in the database, or a live broadcast that has a very minimal recording delay time. The interpolation engine will receive the current timecode from the input and search the database for the data at that position in time, and will determine an estimate of what the exact values were of the data on that particular frame in time. The graphic overlays will be produced and subsequently layered together into a single “fill and key” signal with a video keyer. The final output can then be delivered by combining the output fill and key in another device, such as a production switcher, or the output fill and key can be combined with the high resolution video internally. This is referred to as either internal keying or external keying, where external keying refers to outputting the fill and key channels, and internal keying refers to creating the final composited video internally.

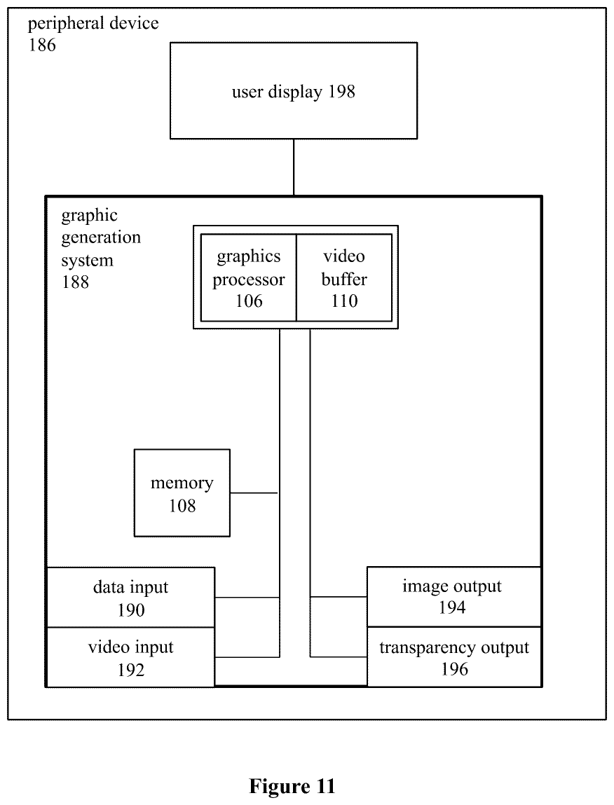

FIG. 11 is a diagram of a system for video graphic generation on a peripheral viewing device. The graphic generation system 188 comprises a data input 190 for receiving a data stream, a video input 192 for receiving a video stream, an image output 194 for sending the created video graphic overlay image to the user display 198 on the peripheral device 186, and optionally, a transparency output 196 for adding transparency to the graphic image. In this embodiment, the graphic generation system 188 can be entirely on peripheral device 186, and the memory 108 on peripheral device 196 can store the graphics engine and/or graphic element library containing one or more graphic elements or graphic element templates or image generation platforms. The graphic element templates in the graphic element library have a modifiable field or feature that can be changed based on the data stream received from data input 190. The data input 190 receives a data stream along with a timecode relevant to the video stream that can be synchronized with the timecode on the video stream such that the data field or feature in the generated graphic image is relevant to the video at the same timestamp when the video and graphic image are displayed together on the user display 198. Graphics processor GPU 106 and video buffer 110 are used to incorporate the data from the data stream into the graphic image template to create the graphic image for display. On the user display 198 on the peripheral device 186, the graphic image can be displayed on top of the video, next to the video, or in a different place on the user display 198 in a different location in the field of view on the user display 198 of the peripheral device 186. In this embodiment, the data stream to data input 190 and the video stream to video input 192 can be received wirelessly via a receiver in the peripheral device 186 from a network, such as, for example, an IP stream, internet, or local network. In the peripheral device 186, the image output 194 and transparency output 196 can be output as two separated streams or as a combined single stream for visual display on the user display 198 of the peripheral device 186. It is understood that, like a video stream, the graphic image output to the user display 198 contains a pixelated digital image which can be still or static over the period of time of when the graphic image is displayed.

To create a graphical image for a video, the graphic generation system receives a video comprising a video stream, the video stream having a plurality of frames in sequence in time, along with a video timecode comprising a timestamp for each frame in the video stream. A graphic element template is then selected from a graphic element library or database of graphic elements, where the graphic element template has a data field that can be populated by a data stream received from a data input. The data stream also has a timecode that can be synchronized with the timecode on the video stream. The graphic element template has an image and also preferably a transparency for the image. To generate the graphic element for viewing, the data field in the graphic element is then populated with data received from the data stream as identified by the timecode. The data used to populate the graphic template can be either at the same location in the timecode, or can be populated by interpolating the data around a specific timestamp in the timecode. The modified graphic image with the time-specific data can then be displayed on top of or alongside the video stream, where the data presented in the graphic image is synchronized with the timecode of the video. The peripheral device can be, for example, a smartphone, tablet, smart TV, headset, heads-up display, virtual reality display, augmented reality display, or other viewing device.

The present graphic overlay device can also be used with OBS (Open Broadcaster Software) with optional audio integration, including multi-stream audio from multiple microphone/audio sources in live broadcasting. Additionally, multiple video channels with multiple frame rate speeds (e.g. 240+ Hz) can be integrated into the video input stream for enabling slow motion playbacks, along with 30-60 Hz for regular speed video.

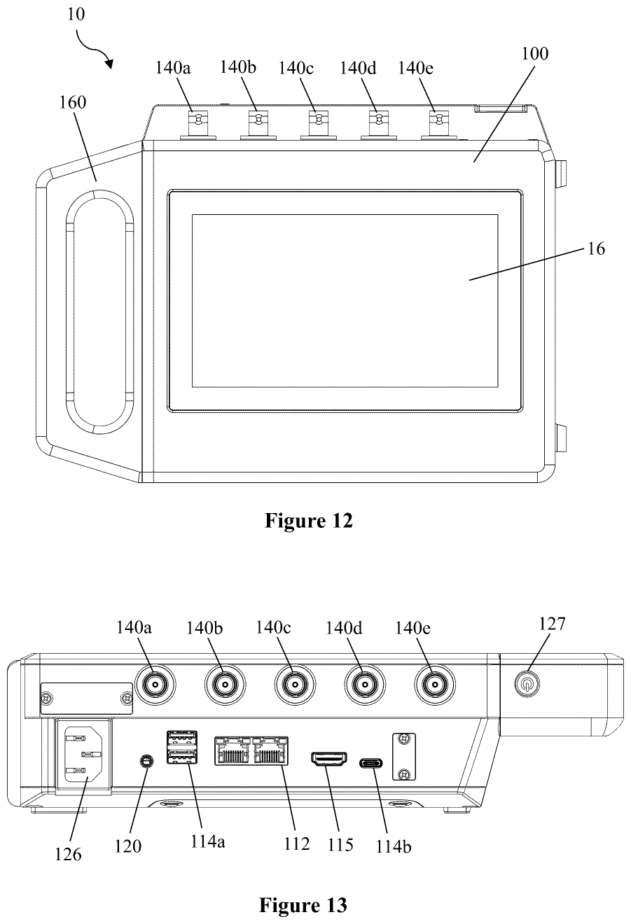

FIG. 12 is a front view of a graphic overlay device 10 in a showing the display screen 16 in a device case 100 with a handle 160. The present graphic overlay device 10 provides a valuable tool for video processing and high quality video editing and augmentation in the fast paced, high pressure environment of live broadcasting. Device case 100 is designed to provide a protective environment for sensitive electronics therein will providing portability and durability for connection to a plurality of digital channels through serial digital interfaces (SDI) 140a-140e.

FIG. 13 is a top view of a graphic overlay device with data and power ports. Serial digital interfaces (SDI) 140a-140e as well as audio port 120, USB ports 114a, 114b, ethernet port 112, and HDMI port 115 provide various points of data in/out to the graphic overlay device. Power supply 126 and power button 127 provide power and power control to the device.

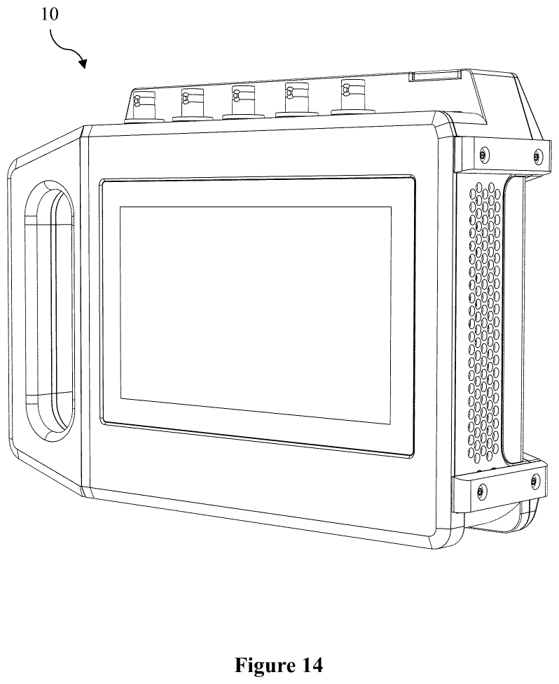

FIG. 14 is a perspective view of a graphic overlay device 10 as described herein.

All publications, patents and patent applications mentioned in this specification are indicative of the level of skill of those skilled in the art to which this invention pertains and are herein incorporated by reference. The reference to any prior art in this specification is not, and should not be taken as, an acknowledgement or any form of suggestion that such prior art forms part of the common general knowledge.

The invention being thus described, it will be obvious that the same may be varied in many ways. Such variations are not to be regarded as a departure from the scope of the invention, and all such modifications as would be obvious to one skilled in the art are intended to be included within the scope of the following claims.

We claim:

1. A video graphic overlay device comprising:
a memory comprising a graphics engine for providing a graphic element template;
a video input port for receiving a video stream and a video stream timecode;
a data input port for receiving a data stream pertinent to the video stream;
a graphics processor for receiving the graphic element template from the graphics engine and the data stream and generating a graphic element overlay incorporating sampled data from the data stream;
a display screen for displaying the video stream and the graphic element overlay; and
an output port for outputting an output data stream comprising the video graphic overlay synchronized with the video stream timecode.

2. The device of claim 1, wherein the output data stream comprises a fill output for relaying an output fill and a key output for relaying an output key for the video graphic overlay.

3. The device of claim 1, wherein the graphic element template and the video graphic overlay comprise a color channel (RGB) and an alpha channel (A).

4. The device of claim 1, wherein the data input port, the video input port, and the output comprise a port selected from a High-Definition Multimedia Interface (HDMI) port and a serial digital interface (SDI) port.

5. The device of claim 1, further comprising an interpolation engine to receive the data stream and interpolate the sampled data from the data stream.

6. The device of claim 1, further comprising one or more of a video buffer, frame buffer, Wi-Fi antenna, fan, and thermostat.

7. The device of claim 1, further comprising an integrated power supply.

8. The device of claim 1, wherein the data stream comprises one or more of a historical data set, a real time data set, and a generated data set.

9. The device of claim 1, wherein the graphics engine comprises at least one of a graphic library and a graphic generation engine.

10. The device of claim 1, wherein the video graphic overlay is a telestrator graphic, clock and score, chyron, ticker, static graphic, augmented static graphic, augmented video effect, or animation.

11. The device of claim 1, wherein the output data stream further comprises the video stream.

12. A computer-implemented method for applying a video graphic overlay to a video comprising:
receiving a video data stream comprising a video stream and a video stream timecode;
receiving a data stream pertinent to the video stream;
generating a graphic element overlay by selecting a graphic element template from a graphics engine and incorporating sampled data from the data stream into the graphic element template;
providing the graphic element overlay to a graphics processor to provide a video graphic overlay; and
outputting an output data stream comprising the video graphic overlay synchronized with the video stream timecode.

13. The method of claim 12, wherein the video graphic overlay is overlayed onto a synchronized live video stream using the video stream timecode.

14. The method of claim 12, wherein the video graphic overlay is overlayed onto a high resolution video stream.

15. The method of claim 12, further comprising interpolating the sampled data from the data stream to provide interpolated data and incorporating the interpolated data into the graphic element template to generate the graphic element overlay.

16. The method of claim 15, wherein interpolating the data input extrapolates a future event based on the interpolated data.

17. The method of claim 12, further comprising displaying the video graphic overlay with a high resolution video stream to provide a video product, the video graphic overlay synchronized with the high resolution video stream according to the video stream timecode.

18. The method of claim 12, wherein the video graphic overlay comprises an output fill and an output key.

19. The method of claim 12, wherein the graphic element template is a telestrator graphic, clock and score, chyron, ticker, static graphic, augmented static graphic, augmented video effect, or animation.

20. The method of claim 12, wherein the graphic element template is provided by a graphics engine.
